(19) United States
(12) Patent Application Publication
(10) Pub. No.: US 2016/0271713 A1
(43) Pub. Date: Sep. 22, 2016

(54) CHAINSAW FILE STORAGE AND FILING KIT, CHAINSAW FILE STORAGE UNIT, AND RELATED METHODS

(71) Applicants: Monte ELSWICK, Lothian, MD (US); Joseph ELSWICK, Upper Marlboro, MD (US)

(72) Inventors: Monte ELSWICK, Lothian, MD (US); Joseph ELSWICK, Upper Marlboro, MD (US)

(21) Appl. No.: 15/070,575

(22) Filed: Mar. 15, 2016

Related U.S. Application Data
(60) Provisional application No. 62/134,222, filed on Mar. 17, 2015.

(51) Int. Cl. B23D 63/16; B23D 63/10; B65D 85/00; B65D 43/02; B65D 25/28

(52) U.S. Cl. CPC B23D 63/162; B65D 43/02; B65D 25/28; B65D 85/70; B23D 63/10; B65D 2525/283

(57) ABSTRACT

A chainsaw file storage and filing kit includes a chainsaw files and a storage casing for storing the chainsaw files. The storage casing includes a removable first end closure, a second end closure, a handle associated with the first end closure, and a chainsaw file spacer fixed between the first and second end closures. The first end closure has an opening configured to interchangeably receive and secure chainsaw files. The handle permits the first end closure with the first chainsaw file secured thereto to be removed from the storage casing and used for filing operations on chainsaw blades. The chainsaw file spacer includes apertures sized to receive and space chainsaw files from one another. A first aperture is aligned with the opening of the first end closure when the first end closure is attached to the first end of the storage casing.

### CROSS-REFERENCE TO RELATED APPLICATION AND CLAIM OF PRIORITY

This application claims the benefit of priority of U.S. Provisional Application No. 62/134,222 filed Mar. 17, 2015, the complete disclosure of which is incorporated herein by reference.

### FIELD OF THE INVENTION

This invention relates to kits for storing chainsaw files and filing chainsaw blades, to storage units for storing chainsaw files, and to methods of making and using the kits and storage units.

### BACKGROUND

Chainsaw files are used to sharpen chainsaw blades when the blades become worn or rusted. Generally, standard round chainsaw files have a shank-like appearance, with tooth patterns encircling or formed spirally around the files. The files are often made of a metallic material such as steel. Typically, the file is secured at one end to a graspable handle that allows the user to manipulate the file in a back-and-forth motion across the chainsaw to shave off dull chain edges and sharpen the chain. The size of the file must match the size of the chain in order to properly sharpen the chain. For this reason, chainsaw files are available in different diameters. It is not uncommon for multiple files, sometimes each with a respective handle, to be sold as a set to allow the purchaser to sharpen different size chains.

### SUMMARY OF THE INVENTION

A first aspect of the invention provides a chainsaw storage and filing kit including a plurality of chainsaw files adapted to sharpen chainsaw blades and a storage unit for storing the plurality of chainsaw files. The storage unit includes a storage casing, a first end closure detachable from and re-attachable to a first end of the storage casing, a handle, a second end closure closing a second end of the storage casing, and a chainsaw file spacer fixed between the first and second end closures. The first end closure has an opening configured to interchangeably receive and secure the chainsaw files. The handle is associated with the first end closure to permit removal, from the storage casing, of the first end closure with one of the chainsaw files secured to the opening for performance of filing operations on chainsaw blades. The chainsaw file spacer includes a plurality of apertures each sized to receive a corresponding chainsaw file of the plurality of chainsaw files while spacing the chainsaw files from one another. The plurality of apertures includes a first aperture aligned with the opening of the first end closure when the first end closure is attached to the first end of the storage casing so that the chainsaw file secured to the opening of the first end closure is received through the first aperture.

According to a second aspect of the invention, a chainsaw file storage unit is provided for storing a plurality of chainsaw files. The storage unit includes a storage casing, a first end closure detachable from and re-attachable to a first end of the storage casing, a handle, a second end closure closing a second end of the storage casing, and a chainsaw file spacer fixed between the first and second end closures. The first end closure has an opening configured to interchangeably receive and secure chainsaw files. The handle is associated with the first end closure to permit removal of the first end closure, with one of the chainsaw files secured thereto, from the storage casing and performance of filing operations on chainsaw blades while the handle is held by the hand of an operator. The chainsaw file spacer includes a plurality of apertures each sized to receive a corresponding chainsaw file and space the chainsaw files from one another. The plurality of apertures includes a first aperture aligned with the opening of the first end closure when the first end closure is attached to the first end of the storage casing.

A third aspect of the invention provides a method for storing chainsaw files and filing a chainsaw blade. The method involves storing a plurality of chainsaw files in a storage unit. The storage unit includes a storage casing having opposite first and second ends, a first end closure detachable from and re-attachable to the first end of the storage casing and having an opening configured to interchangeably receive and secure the chainsaw files, a handle associated with the first end closure, a second end closure closing the second end of the storage casing, and a chainsaw file spacer fixed between the first and second end closures and including a plurality of apertures each sized to receive a corresponding chainsaw file of the plurality of chainsaw files while spacing the chainsaw files from one another. The plurality of apertures includes a first aperture aligned with the opening of the first end closure when the first end closure is attached to the first end of the storage casing. The method further involves removing the handle with the first end closure associated therewith from the storage casing, securing a selected chainsaw file of the plurality of chainsaw files to the opening of the first end closure, and performing a filing operation on a chainsaw blade by manipulating the handle by hand while the selected chainsaw file is secured to the opening of the first end closure.

Other aspects of the invention, including apparatus, devices, kits, tools, methods of making and using, and the like which constitute part of the invention, will become more apparent upon reading the following detailed description of the exemplary embodiments.

### BRIEF DESCRIPTION OF THE DRAWING(S)

The accompanying drawings are incorporated in and constitute a part of the specification. The drawings, together with the general description given above and the detailed description of the exemplary embodiments and methods given below, serve to explain the principles of the invention. In such drawings:

FIG. 1 is a perspective view of a chainsaw file storage and filing kit according to an embodiment of the invention;

FIG. 2 is a perspective view of a chainsaw filing tool of the chainsaw file storage and filing kit of FIG. 1;

FIG. 3 is a cross-sectional view of a storage unit of the chainsaw file storage and filing kit of FIG. 1;

FIG. 4 is a cross-sectional view taken along sectional line IV-IV of FIG. 3;

FIG. 5 is a cross-sectional view taken along sectional line V-V of FIG. 3;

FIG. 6 is a cross-sectional view taken along sectional line VI-VI of FIG. 3; and

FIG. 7 is a cross-sectional view of an alternative embodiment.

### DETAILED DESCRIPTION OF THE EXEMPLARY EMBODIMENTS AND EXEMPLARY METHODS

Reference will now be made in detail to exemplary embodiments and methods of the invention. It should be noted, however, that the invention in its broader aspects is not necessarily limited to the specific details, representative materials and methods, and illustrative examples shown and described in connection with the exemplary embodiments and methods.

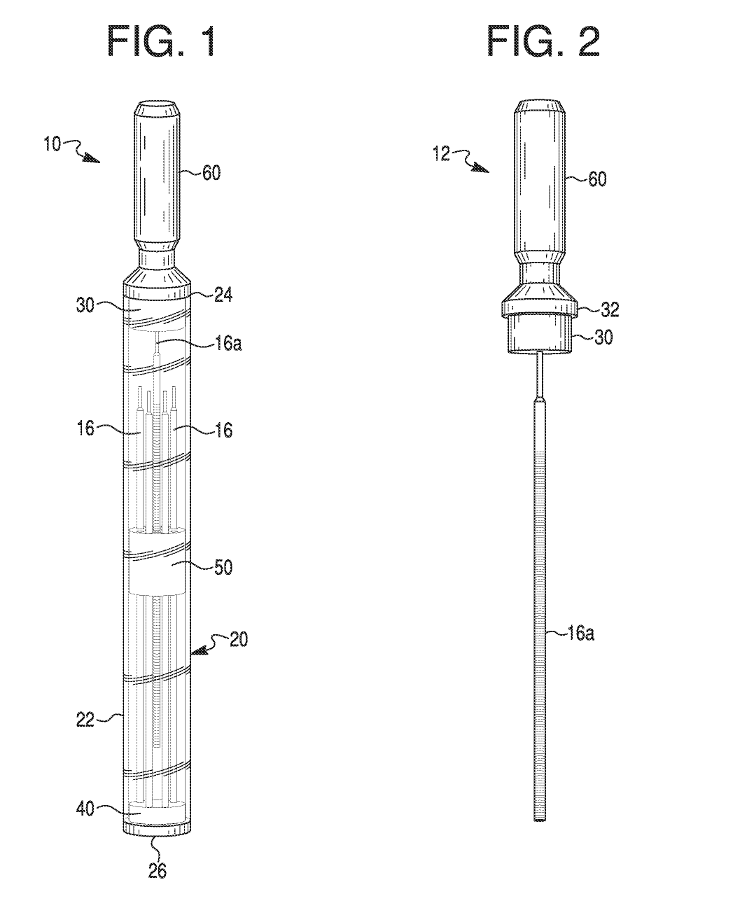

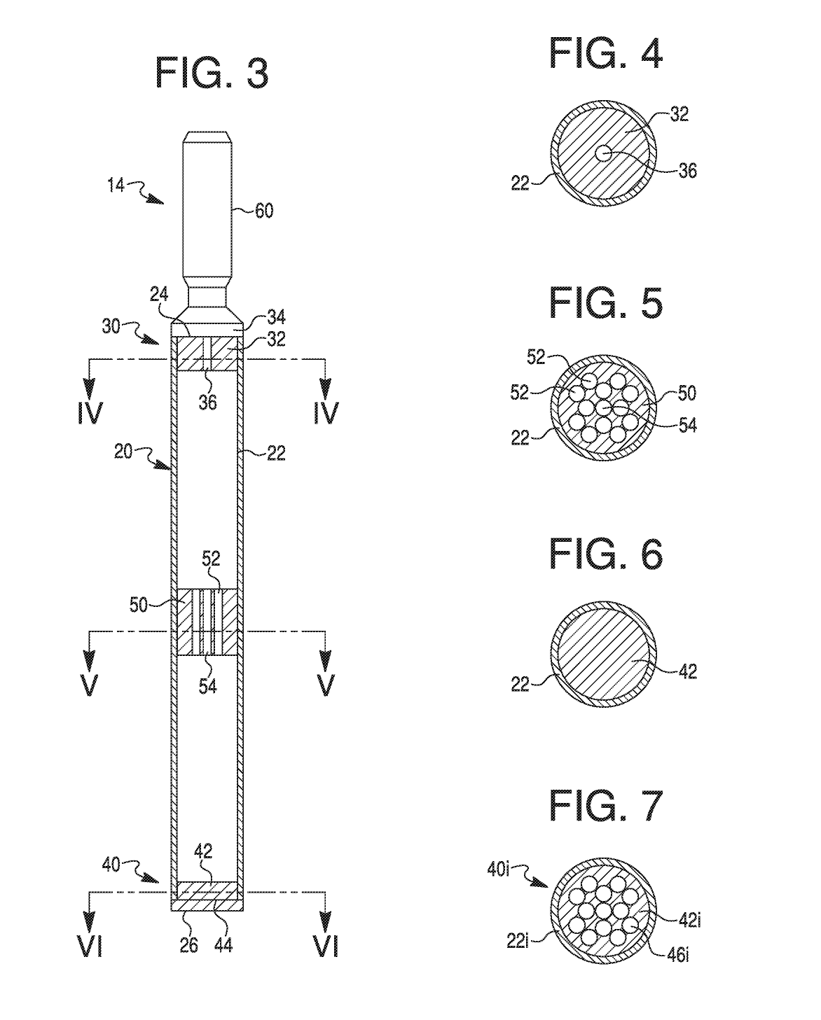

A chainsaw storage and filing kit according to an exemplary embodiment of the present invention is generally designated by reference numeral 10 in FIG. 1. The chainsaw storage and filing kit 10 includes a plurality of chainsaw files 16 adapted to sharpen chainsaw blades and further includes a chainsaw file storage unit 14. The chainsaw files 16 may be “round” files or other types of files adapted for sharpening chainsaw blades. The files 16 typically will be different sizes for use with corresponding size chains. FIG. 2 shows a selected chainsaw file 16a of the plurality of chainsaw files 16 securely engaging a handle 60 (discussed below) of the chainsaw file storage unit 14 to establish a chainsaw blade filing tool 12. FIG. 3 shows the storage unit 14 without the chainsaw files 16, 16a.

As best shown in FIGS. 1 and 3, the chainsaw file storage unit 14 includes a storage casing 20 having a hollow cylindrical (tubular) casing wall 22 extending longitudinally between a first end 24 and an opposite second end 26. When the storage unit 14 is stood in upright position, as shown in FIGS. 1 and 3, the first end 24 is an upper or top end of the storage casing 20 and the second end 26 is a lower or bottom end of the storage casing 20. The bottom of the second end 26 may be flat so as to allow the storage unit 14 to stand upright without a supporting structure. The casing wall 22 may be made of any material suitable for its intended use of storing the chainsaw files 16. In many instances it may be desirable for the casing wall 22 to be made of a transparent material, such as a plastic (e.g., polycarbonate or PVC), for easier viewing of the chainsaw files in the storage unit 14. The casing wall 22 is sufficient in length to accommodate standard chainsaw files 16. By way of example, the casing wall 22 may be approximately 10-14 inches in length (height), for example approximately 12.5 inches in length. The diameter of the casing wall 22 may vary depending upon, among other considerations, the number of chainsaw files 16 to be stored in the kit 10. By way of example, the casing wall 22 may be approximately 1.5-2 inches in diameter (width), more specifically approximately 1.6 inches in diameter, with a wall thickness of approximately ⅛ (0.125) inch to approximately ¼ (0.25) inch. It should be understood that the above dimensions are provided by way of example, and that the dimensions may vary.

The chainsaw file storage unit 14 further includes a first end closure 30 detachable from and re-attachable to the first end 24 of the storage casing 20. The first end closure 30 includes a stopper portion 32 and a cap or lid portion 34, shown integral with one another as a unitary piece. The stopper portion 32 is slightly smaller in diameter than the inner diameter of the first end 24 of the storage casing 20 to provide a snug fit for frictional engagement with the storage casing 20. Optionally, the engagement between the stopper portion 32 and the first end 24 of the storage casing 20 may be sufficiently tight to provide an airtight seal for protecting the chainsaw files 16 in the storage casing 20 from water damage and/or rust. According to one modification, the peripheral surface of the stopper portion 32 of the first end closure 30 may be threaded to engage matching screw threads in the inner surface of the first end 24 of the casing wall 22. It should be understood that non-permanent fasteners may also be used for detachably and re-attachably connecting the first end closure 30 to the first end 24 of the storage casing 20. The detachability of the first end closure 30 relative to the casing wall 22 permits the user to, among other things, access the chainsaw files 16 stored in the storage casing 20. The reattachability allows the storage casing 20 to be closed and optionally resealed.

The stopper portion 32 of the first end closure 30 has an opening 36 best shown in FIGS. 3 and 4. The opening 36 may be cylindrical and configured with a diameter approximately equal to the diameter of the end of a chainsaw file to interchangeably receive and frictionally secure the selected chainsaw file 16a. As best shown in FIG. 4, the opening 36 is centrally located in the stopper portion 32 of the first end closure 30.

As best shown in FIGS. 3 and 6, the chainsaw file storage unit 14 further includes a second end closure 40 closing the second end of the storage casing 20. Like the first end closure 30, the second end closure 40 includes a stopper portion 42 and a cap or lid portion 44 shown integrally formed with the stopper portion 42 as a unitary piece. The second end closure 40 optionally may provide an airtight seal at the second end 26 of the storage casing 20 for protecting the chainsaw files 16 in the storage casing 20 from water damage and/or rust. Optionally, the second end closure 40 may be permanently attached and/or adhesively bonded to the second end 26 of the storage casing 20. Alternatively, the second end closure 40 may be detachably and re-attachably connected to the second end 26 of the storage casing 20, for example, with screw threads or a fastener.

As best shown in FIGS. 3 and 5, a chainsaw file spacer 50 is fixed, such as by adhesive bonding, fastener, or frictional fit, to the casing wall 22. The spacer is spaced apart from and located between the first end closure 30 and the second end closure 40. The chainsaw file spacer 50 includes a plurality of apertures 52 each sized to receive a corresponding chainsaw file of the plurality of chainsaw files 16, 16a while spacing the chainsaw files 16, 16a from one another. The apertures 52 include a central aperture 54 aligned with the opening 36 of the first end closure 30 when the first end closure 30 is attached to the first end 24 of the storage casing 20. The apertures 52, 54 extend through the entire length of the spacer 50. When the selected chainsaw file 16a is secured to the opening 36 of the first end closure 30, the selected chainsaw file 16a is received through the central aperture 54 of the spacer 50.

In the illustrated embodiment, the chainsaw file spacer 50 includes twelve of the non-central apertures 52 located around the thirteenth central aperture 54. Alternatively, the chainsaw file spacer 50 may include two, three, four, five, or more of the apertures 52, 54. The apertures 52, 54 may be arranged in a honeycomb configuration, as best shown in FIG. 5. The apertures 52, 54 are slightly larger than the diameters of the chainsaw files 16, 16a to allow the files 16, 16a to be slid longitudinally into and out of the spacer 50.

When the storage unit 14 is in upright standing position, as shown in FIG. 1, the apertures 52, 54 may retainer the files 16, 16a in spaced, contact-free relationship to one another and to the casing wall 22. The bottom ends of the files 16 rest on the upper surface of the second end closure 40, as shown in FIG. 1. Because the selected file 16a is engaged in the opening 36 of the first end closure 30, the lower end of the selected file 16a is suspended above the upper surface of the second end closure 40.

In an alternative embodiment shown in FIG. 7, the storage unit 14 includes a second end closure 40i having a stopper portion 42i with an upper surface having a plurality of pockets 46i that correspond in arrangement to the apertures 52. The pockets 46i may penetrate partly but not entirely through the second end closure 40i. Each one of the pockets 46i is longitudinally aligned with a corresponding one of the apertures 52. In this manner, the files 16 received in the apertures 52 of the spacer 50 have their ends received in respective aligned pockets 46i of the second end closure 40i. The chainsaw files 16 are thereby more stably retained with two points of contact (one at a corresponding aperture 52 and another at a corresponding pocket 46i) in spaced relation to one another and to the casing wall 22.

The first end closure 30, the second end closure 40/40i, and the chainsaw file spacer 50 may be made of the same or different materials from one another and the storage casing 20. Transparent materials may be desirable. For example, the end closures 30, 40 and the spacer 50 may be made of solid polyvinylchloride (PVC) or polycarbonate stock material. The opening 36 and apertures 52, 54 (and optional pockets 46i of the alternative second end closure 40i discussed above) may be drilled or otherwise formed in the first end closure 30 and the spacer 50 (and the alternative second end closure 40i).

The chainsaw file storage unit 14 still further includes a handle 60 associated with the first end closure 30. In the illustrated embodiment, the handle 60 is integrally formed with the first end enclosure 30 as a single unitary piece. The handle 60 is shaped to be gripped by a human hand, and may include a non-slip grip. FIG. 2 shows the handle 60 and the first end closure 30 with the selected chainsaw file 16a received in the opening 36 of the first end enclosure 30 to collectively establish the sharpening tool 12.

In operation, the user grasps the handle 60 and pulls it from the storage casing 20 to extract the chainsaw file 16a received in the opening 36 from the storage casing 20. The handle 60 and the chainsaw filed 16a collective establish the sharpening tool 12 that is adapted for use in sharpening chainsaw blades. Alternatively, if the selected chainsaw file 16a is not already received in the opening 36, the handle 60 may be removed from the storage casing 20, followed by retrieval of one of the chainsaw files 16 from the storage casing 20 for secure attachment to the opening 36 of the first end closure 30. The selected chainsaw file 16a may be press fit into the opening 36 for secure frictional-fit attachment. Alternatively, the ends of the chainsaw files 16 and the opening 36 may have complementary screw threads for providing secure engagement by rotating the chainsaw files relative to the opening 36. After the chainsaw file 16a is securely received in the opening 36, the user may manipulate the resulting tool 12, generally by back and forth movement, to conduct filing operations on a chainsaw blade in a manner known in the art and demonstrated, for example, on various publicly available Internet sites.

The casing wall 22 may be cut from stock plastic tubing, such as PVC or polycarbonate tubing. The end closures 30, 40, the spacer 50, and the handle 60 similarly may be cut or lathed from stock plastic or may be molded, e.g., injection molded. The opening 36, apertures 52, 54, and optional pockets 46i may be formed during molding or post-formed in a drilling or other operation. Adhesive may be used for permanently securing the second end closure 40 and the spacer 50 to the casing wall 22.

The chainsaw storage and filing kits and the chainsaw storage units described herein are especially useful for allowing manufacturers to conveniently package their products as a tool having interchangeable files storable in a convenient unit. The chainsaw storage and filing kits and chainsaw storage units are also advantageous in allowing end users to safely store and transport chainsaw files in a manner conducive to preventing or reducing rust and dulling of the files. Further, the integration of the handle into the storage unit provides a space-saving and convenient package and reduces the risk of the handle being lost or separated from the remainder of the unit or kit.

The foregoing detailed description of the certain exemplary embodiments has been provided for the purpose of explaining the principles of the invention and its practical application, thereby enabling others skilled in the art to understand the invention for various embodiments and with various modifications as are suited to the particular use contemplated. This description is not necessarily intended to be exhaustive or to limit the invention to the precise embodiments disclosed. The specification describes specific examples to accomplish a more general goal that may be accomplished in another way.

For purposes of interpreting the claims for the present invention, it is expressly intended that the provisions of Section 112, sixth paragraph of 35 U.S.C. be presumed not to be invoked unless the specific terms “means for” or “step for” are recited in a claim, unless necessary to save the validity of the claim.

What is claimed is:

1. A chainsaw storage and filing kit, comprising:
a plurality of chainsaw files adapted to sharpen chainsaw blades; and
a storage unit for storing the plurality of chainsaw files, the storage unit comprising
a storage casing having opposite first and second ends;
a first end closure detachable from and re-attachable to the first end of the storage casing, the first end closure having an opening configured to interchangeably receive and secure the chainsaw files to the first end closure;
a handle associated with the first end closure to permit removal of the first end closure with one of the chainsaw files secured to the opening from the storage casing for performance of filing operations on the chainsaw blades;
a second end closure closing the second end of the storage casing; and
a chainsaw file spacer fixed between the first and second end closures, the chainsaw file spacer comprising a plurality of apertures each sized to receive a corresponding chainsaw file of the plurality of chainsaw files while spacing the chainsaw files from one another, the plurality of apertures comprising a first aperture aligned with the opening of the first end closure when the first end closure is attached to the first end of the storage casing so that the chainsaw file secured to the opening of the first end closure is received through the first aperture.

2. The chainsaw file storage and filing kit of claim 1, wherein the storage casing is cylindrical.

3. The chainsaw file storage and filing kit of claim 1, wherein the storage casing is approximately 10-14 inches tall.

4. The chainsaw file storage and filing kit of claim 1, wherein the opening of the first end closure is centrally positioned in the storage casing when the first end closure is attached to the storage casing.

5. The chainsaw file storage and filing kit of claim 11, wherein the second end closure has a surface facing inwardly towards the storage casing, and wherein the surface comprises a plurality of pockets, each of the pockets being aligned with a corresponding one of the apertures of the spacer.

6. The chainsaw file storage and filing kit of claim 1, wherein the first end closure comprises a first cap portion that rests on the first end of the storage casing and a stopper portion that is sealingly received in the first end of the storage casing when the first end closure is attached to the first end of the storage casing.

7. The chainsaw file storage and filing kit of claim 6, wherein the second end closure sealingly closes the second end of the storage casing, the first and second end closures providing an airtight seal when the stopper portion of the first end closure is sealingly received in the first end of the storage casing.

8. The chainsaw file storage and filing kit of claim 1, wherein the apertures of the chainsaw file spacer are spaced relative to one another in honeycomb configuration.

9. The chainsaw file storage and filing kit of claim 1, wherein the handle is integrally formed with the first end closure as a unitary piece.

10. The chainsaw file storage and filing kit of claim 1, wherein the chainsaw file spacer is made of polyvinylchloride.

11. A chainsaw file storage unit for storing a plurality of chainsaw files, the chainsaw file storage unit comprising:
a storage casing having opposite first and second ends;
a first end closure detachable from and re-attachable to the first end of the storage casing, the first end closure having an opening configured to interchangeably receive and secure the chainsaw files to the first end closure;
a handle associated with the first end closure to permit removal of the first end closure with one of the chainsaw files secured to the opening from the storage casing for performance of filing operations on chainsaw blades;
a second end closure closing the second end of the storage casing; and
a chainsaw file spacer fixed between the first and second end closures, the chainsaw file spacer comprising a plurality of apertures each sized to receive a corresponding chainsaw file of the plurality of chainsaw files while spacing the chainsaw files from one another, the plurality of apertures comprising a first aperture aligned with the opening of the first end closure when the first end closure is attached to the first end of the storage casing.

12. The chainsaw file storage unit of claim 1, wherein the storage casing is cylindrical.

13. The chainsaw file storage unit of claim 11, wherein the storage casing is approximately 10-14 inches tall.

14. The chainsaw file storage unit of claim 11, wherein the opening of the first end closure is centrally positioned in the storage casing when the first end closure is attached to the storage casing.

15. The chainsaw file storage unit of claim 11, wherein the second end closure has a surface facing inwardly towards the storage casing, and wherein the surface comprises a plurality of pockets, each of the pockets being aligned with a corresponding one of the apertures of the spacer.

16. The chainsaw file storage unit of claim 11, wherein the first end closure comprises a first cap portion that rests on the first end of the storage casing and a stopper portion that is sealingly received in the first end of the storage casing when the first end closure is attached to the first end of the storage casing.

17. The chainsaw file storage unit of claim 16, wherein the second end closure sealingly closes the second end of the storage casing, the first and second end closures providing an airtight seal when the stopper portion of the first end closure is sealingly received in the first end of the storage casing.

18. The chainsaw file storage unit of claim 11, wherein the apertures of the chainsaw file spacer are spaced relative to one another in honeycomb configuration.

19. The chainsaw file storage unit of claim 11, wherein the handle is integrally formed with the first end closure.

20. A method for storing chainsaw files and filing a chainsaw blade, the method comprising:
storing a plurality of chainsaw files in a chainsaw file storage unit, the storage unit comprising a storage casing having opposite first and second ends, a first end closure detachable from and re-attachable to the first end of the storage casing and having an opening configured to interchangeably receive and secure the chainsaw files to the first end closure, a handle associated with the first end closure, a second end closure closing the second end of the storage casing, and a chainsaw file spacer fixed between the first and second end closures and comprising a plurality of apertures each sized to receive a corresponding chainsaw file of the plurality of chainsaw files while spacing the chainsaw files from one another, the plurality of apertures comprising a first aperture aligned with the opening of the first end closure when the first end closure is attached to the first end of the storage casing;
removing the handle from the storage casing;
securing a selected chainsaw file of the plurality of chainsaw files to the opening of the first end closure; and
performing a filing operation on a chainsaw blade by manipulating the handle by hand while the selected chainsaw file is secured to the opening of the first end closure.
